(19) United States
(12) Patent Application Publication
(10) Pub. No.: US 2009/0281834 A1
(43) Pub. Date: Nov. 12, 2009

(54) SYSTEM AND METHOD FOR MANAGING INFORMATION OF DORMANT PATIENTS

(75) Inventor: Jong Hyo Kim, Seoul (KR)

Correspondence Address: RABIN & Berdo, PC, 1101 14TH STREET, NW, SUITE 500, WASHINGTON, DC, 20005, US

(73) Assignee: SEOUL NATIONAL UNIVERSITY HOSPITAL, Seoul (KR)

(21) Appl. No.: 12/297,124

(22) PCT Filed: Apr. 19, 2007
(86) PCT No.: PCT/KR07/01904

§ 371 Date: Oct. 14, 2008

(30) Foreign Application Priority Data
Apr. 19, 2006 (KR) 10-2006-0035481

(51) Int. Cl. G06Q 50/00; G06Q 10/00

(52) U.S. Cl. 705/3; 705/2

(57) ABSTRACT

Disclosed herein is a system and method for managing information of dormant patients and, more particularly, to such a system and method in which the information of dormant patients is stored and managed in a separate storage server.

### TECHNICAL FIELD

The present invention relates to a system and method for managing information of dormant patients and, more particularly, to such a system and method in which the information of dormant patients is stored and managed in a separate storage server.

### BACKGROUND ART

In general, a picture archiving communication system (PACS) refers to a system in which various image data in a medical institution is stored in a computer, accessed, if necessary, and displayed a monitor. It is reported PACS can increase the diagnosis efficiency and reduce the cost of managing the image data.

The existing picture archiving communication system accumulates and stores the picture data and information related to all the patients who have visited the hospital and taken exam. Here, the amount of the picture data and related information accumulated in the system increases proportionally as years go by, thus causing a problem of increased management cost and deteriorated system performance. Although the custody term of the image data of patients is set according to the local regulations of the country or state where the medical institution is located, many medical institutions want to keep the picture data and related information image data for a long time for better efficiency of patient care and medical research.

For example, supposed that the number of image exams per year is five hundred thousand cases and the average number of image data per exam is one hundred in a general hospital accommodating one thousand patients, if the management term of the corresponding picture archiving communication system has passed ten years, the number of exams and the number of image data will increase to five million cases and five hundred million cases, respectively.

To solve the increasing amount of image data as described above, the conventional picture archiving communication system uses a method in which the storage units of the image data are divided into multi-steps and the image data are classified into multiple categories according to their possibility of being accessed and stored in the respective storage units suitable for their uses.

However, since the performance of the picture archiving communication system is affected by the speed of storage units, the performance of the picture archiving communication system is deteriorated as much as the amount of the image data accumulated in the storage units increases. Accordingly, such a method in which the image data is managed by dividing the storage units into multi-steps as described above is not a radical solution for the problem and the performance is inevitably deteriorated as the management term goes by.

Meanwhile, as the degree of dependence on such the information system of the medical institution has been increased, the investment cost of the information system increases gradually. Moreover, the cost expended to configure and maintain a system in preparation for unexpected failures in the operational information system occupies a large portion of the total cost. Since such a cost for the system in preparation for the possible failure increases in proportion to the information amount to be managed, the image data increasing amount of image data being accumulated in the picture archiving communication system is a direct cause for an increase in the management cost thereof.

Although it has not been for a long time since the picture archiving communication systems have been adopted in medical institutions, the information amount accumulated will continuously increase as time goes by. Moreover, since the amount of image data generated per every exam increases rapidly, the information amount accumulated will increase exponentially, thereby the existing method of data management must cause various problems in that the performance of the picture archiving communication system must be deteriorated and the management cost must also be increased.

Accordingly, to solve the above-described problems, the necessity of a new information management method, through which the performance of the information management system can be maintained even if the operational year is extended for a long time and further the management cost will be maintained at an acceptable level, has been raised.

### DISCLOSURE OF INVENTION

### Technical Problem

The present invention have been contrived taking the above-described circumstances into consideration, and an object of the present invention is to provide a system and method for managing information of dormant patients in which the performance of the system is maintained even if the operational year is extended for a long time and further maintain the management cost at an acceptable level.

Other objects and advantages of the present invention will be described below and identified by preferred embodiments of the present invention. Moreover, the objects and advantages of the present invention can be embodied by means and combinations set forth in the appended claims.

### Technical Solution

To accomplish the above objects of the present invention, there is provided a system for managing information of dormant patients comprising a picture archiving communication server including a plurality of patient folders containing patient-related information and image data, and a dormant patient information storage server including a plurality of dormant patient folders containing dormant patient-related information and image data, wherein the picture archiving communication server includes: a filter unit that searches for the patient list stored in the picture archiving communication server at a time that a user presets to decide dormant state under predetermined dormant conditions, classifies a folder, in which the dormant patient-related information and image data of a dormant patient decided as a dormant state are stored, as a dormant patient folder, and records an identifier of the dormant patient folder in a dormant identifier list to be stored; and an information transfer unit that reads the dormant identifier list stored in the filter unit at a time that the user presets to transmit the related information and image data in the dormant patient folder corresponding to the dormant identifier list to an information storage unit of the dormant patient information storage server, and deletes the related information and image data in the dormant patient folders in the picture archiving communication server except for minimum identification information, wherein the dormant patient information storage server includes an information storage unit receiving and storing the dormant patient-related information and image data transmitted from the information transfer unit, and wherein the dormant patient information storage server has system requirements lower than those of the picture archiving communication server includes.

Here, it is desirable that, if there is any one of a visit reservation, an exam reservation of a dormant patient decided as a dormant state and a demand of the user, the filter unit should classify the dormant patient folder of the information storage unit, in which the dormant patient-related information and image data are stored, as a restoring patient folder and recode an identifier of the restoring patient folder in a restoring identifier list to be stored.

Moreover, it is desirable that an information restoring unit transmitting the patient-related information and image data stored in the restoring patient folder of the information storage unit to the picture archiving communication system to restore the corresponding folder, if there is an added item after conducting a search for the restoring identifier list stored in the filter unit at a time that the user presets, should be further included.

Meanwhile, it is desirable that the dormant patient folders of the information storage unit should be compressed and stored and, if restoring the dormant patient folder, the dormant patient folders should be decompressed and restored. Moreover, it is desirable that, if the related information and image data in the dormant patient folders corresponding to the dormant identifier list are transmitted to the information storage unit of the dormant patient information storage server and the related information and image data in the dormant patient folders in the picture archiving communication server are deleted except for the minimum identification information, the minimum identification information should include any one of a resident registration number of the patient and a code that the medical institution allots.

Furthermore, it is desirable that, if a visit reservation of a dormant patient entered in the restoring identifier list is cancelled, the filter unit should classify the restoring patient folder of the information storage unit of the corresponding patient as a dormant patient folder again and deletes a folder identifier of the corresponding patient from the restoring identifier list, and record an identifier of the dormant patient folder in the dormant identifier list to be stored again.

To accomplish the above objects of the present invention, there is provided a method for managing information of dormant patients in a system for managing information of dormant patients comprising a picture archiving communication server including a plurality of patient folders containing patient-related information and image data, and a dormant patient information storage server including a plurality of dormant patient folders containing dormant patient-related information and image data, the method comprising: a filtering step of searching for medical records of patients stored in the picture archiving communication server at a time that a user presets to decide dormant state under predetermined dormant conditions, classifying a folder, in which the dormant patient-related information and image data of a dormant patient decided as a dormant state are stored, as a dormant patient folder, and recording an identifier of the dormant patient folder in a dormant identifier list to be stored; an information transfer step of reading the dormant identifier list stored in the filtering step at a time that the user presets to transmit the related information and image data in the dormant patient folder corresponding to the dormant identifier list to an information storage unit of the dormant patient information storage server, and deleting the related information and image data in the dormant patient folders in the picture archiving communication server except for minimum identification information; and an information storing step of receiving and storing the dormant patient-related information and image data transmitted in the information transfer step.

Here, it is desirable that a step of classifying the dormant patient folder of the information storage unit, in which the dormant patient-related information and image data are stored, as a restoring patient folder, recoding an identifier of the restoring patient folder in a restoring identifier list to be stored, if there is any one of a visit reservation, an exam reservation of a dormant patient decided as a dormant state and a demand of the user, should be further included.

Moreover, it is preferable to further include a step of transmitting the patient-related information and image data stored in the restoring patient folder of the information storage unit to the picture archiving communication system to restore the corresponding folder, if there is an added item after conducting a search for the restoring identifier list stored in the filter unit at a time that the user presets.

Meanwhile, it is desirable that the dormant patient folders of the information storage unit should be compressed and stored and, if restoring the dormant patient folder, the dormant patient folders should be decompressed and restored. Moreover, it is desirable that, if the related information and image data in the dormant patient folders corresponding to the dormant identifier list are transmitted to the information storage unit of the dormant patient information storage server and the related information and image data in the dormant patient folders in the picture archiving communication server are deleted except for the minimum identification information, the minimum identification information should include any one of a resident registration number of the patient and a code that the medical institution allots.

Furthermore, it is desirable that a step of classifying the restoring patient folder of the information storage unit of the corresponding patient as a dormant patient folder again, deleting a folder identifier of the corresponding patient from the restoring identifier list, and recording an identifier of the dormant patient folder in the dormant identifier list to be stored again, if a visit reservation of a dormant patient entered in the restoring identifier list is cancelled, should be further included.

### ADVANTAGEOUS EFFECTS

The system and method for managing information of dormant patients in accordance with the present invention provide the following effects.

First, it is possible to manage the system efficiently by classifying the information continuously accumulated into an active state and a dormant state, in which the information in the active state is left in the picture archiving communication server for the management and the information in the dormant state is transmitted to the dormant patient information storage server.

Second, since the amount of information accumulated in the storage unit of the picture archiving communication server can be maintained at an appropriate level, it is possible to solve the problems in that the system performance is deteriorated as the amount of information accumulate in the storage unit is increased.

Consequently, the performance of the picture archiving communication server can be improved.

Third, it is possible to reduce the maintenance cost of the system as the performance of the picture archiving communication server is improved.

Last, even if the management term is extended, the amount of information managed in the picture archiving communication server can be maintained at an appropriate level. Accordingly, it is possible to maintain the operational cost of the system at an acceptable level while maintaining its preparedness for an unexpected failure.

### BRIEF DESCRIPTION OF THE DRAWINGS

FIG. 1 is block diagram depicting a system for managing information of a dormant patient in accordance with a preferred embodiment of the present invention; and

FIGS. 2 and 3 are flowcharts depicting a method for managing information of a dormant patient in accordance with a preferred embodiment of the present invention.

### BEST MODE FOR CARRYING OUT THE INVENTION

Hereinafter, preferred embodiments of the present invention will now be described with reference to the accompanying drawings.

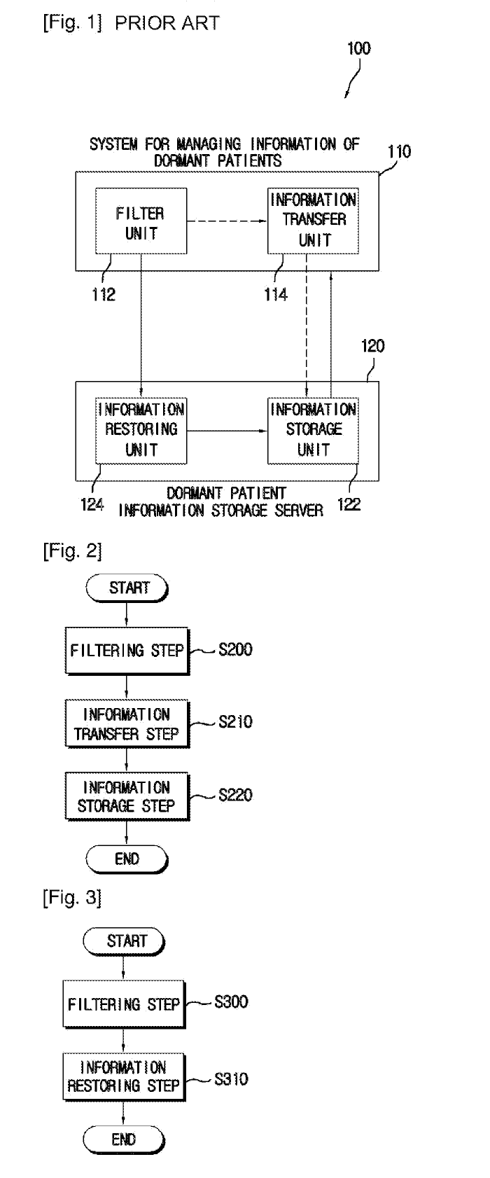

FIG. 1 is block diagram depicting a system for managing information of a dormant patient in accordance with a preferred embodiment of the present invention, and FIGS. 2 and 3 are flowcharts depicting a method for managing information of a dormant patient in accordance with a preferred embodiment of the present invention.

First, as depicted in FIG. 1, a system 100 for managing information of dormant patients in accordance with a preferred embodiment of the present invention comprises a picture archiving communication server 110 and a dormant patient information storage server 120. In this specification, a dormant patient refers to a patient whose information including image data has not been used and has been dormant for a predetermined period in the hospital or medical center.

The picture archiving communication server 110 receives and stores digital image data taken through an image diagnosis device. Moreover, the picture archiving communication server 110 processes all functions required for referring to the stored information by transmitting the stored information to the respective terminals.

In the picture archiving communication server 110, a plurality of patients folders including patient-related information and image data is established to prevent the loss of data, thus increasing the management efficiency and as well as the diagnosis efficiency in a medical institution. Here, the information related to a patient includes personal information of a patient, such as a resident registration number, an address, where to make contact, etc., and as well as all recording information related to the diagnosis of the patient, such as a date when the patient visited, a name of a doctor, an exam record, an exam result, etc.

Moreover, the image data is directed to pictures taken through a radiological image diagnosis device and denotes digitalized information taken through medical imaging apparatus, such as computer tomography (CT) apparatus, magnetic resonance imaging (MRI) apparatus, radiography apparatus, angiography apparatus, endoscope, microscope, etc.

Meanwhile, briefly describing the patient folder, it contains information related to a patient written in a database and image data stored in a separate file system and denotes an abstract data form inclusively expressing all information related to the corresponding patient.

Next, the dormant patient information storage server 120, established separately from the picture archiving communication server 110, for storing information related to a dormant patient.

Moreover, a plurality of dormant patient folders including image data and information related to dormant patients who have not been diagnosed in the corresponding medical institution for a time period preset by the user is established to manage the dormant patient information systematically. Here, the information related to a dormant patient contains personal information of a patient who has been judged as a dormant patient, such as a resident registration number, an address, where to make contact, etc., and as well as all previous recording information, such as a date when the patient visited, a name of a doctor, an exam record, an exam result, etc.

Moreover, the image data of the dormant patient is directed to pictures previously taken through a radiological image diagnosis device and denotes digitalized information taken through medical imaging apparatus, such as computer tomography (CT) apparatus, magnetic resonance imaging (MRI) apparatus, radiography apparatus, angiography apparatus, endoscope, microscope, etc.

Briefly describing the dormant patient folder, it contains information related to a patient who has been judged as a dormant patient and image data and it denotes a single data file expressing all information related to the corresponding dormant patient. Moreover, the dormant patient folder includes the same kind of information as the patient folder as described above. It is possible to obtain the information related to the dormant patients or the image data using the dormant patient folder.

Meanwhile, the picture archiving communication server 110 comprises a filter unit 112 and an information transfer unit 114.

The filter unit 112 searches for medical records of a patient, such as a visit record, a visit reservation record, an exam record and the like, stored in picture archiving communication server 110 at the time that the user presets and decides whether or not the corresponding patient is in a dormant state in accordance with predetermined dormant conditions. Moreover, it is possible to set the filter unit 112 to search for the medical records of the patient periodically according to a method that the user presets and further to set the filter unit 112 to conduct a search for the medical records of the patient automatically.

Meanwhile, the method of deciding the dormant state is not limited thereto, but rather the dormant state is decided by searching for the medical records of the patient pursuant to the user's selection. Here, the user is desirably a manager who manages the system 100 for managing information of dormant patients. The dormant state of the patient can be decided by searching for the medical records of the patient at the time when the user executes the system 100 for managing information of dormant patients.

The predetermined dormant conditions denote conditions preset by the system manager and the like and can be determined variously according to the system accuracy, the system complexity and the information amount that the corresponding system can possess. Desirably, if a time period that the patient was diagnosed by the corresponding medical institution lastly exceeds a period preset by the manager, the patient is judged as a dormant patient.

The filter unit 112 that has decided the dormant state of the patients by carrying out the above-described process classifies the folder in which the dormant patient-related information and image data are stored as a dormant patient folder and stores an identifier of the dormant patient folder in a dormant identifier list. Here, the identifier of the dormant patient folder is means for identifying the dormant patient folder and it is desirable that the dormant patient folder be identified by any one of a name, an address, where to make contact, a resident registration number of the patient and a code that the medical institution allots.

Meanwhile, the information transfer unit 114 reads the dormant identifier list stored in the filter unit 112 at the time that the user presets and transfers the dormant patient-related information and image data in the dormant patient folder corresponding to the dormant identifier list to an information storage unit 122 of the dormant patient information storage server 120.

In more detail, if an identifier of a dormant patient folder is added to the dormant identifier list by reading the dormant identifier list at the time that the user, i.e., the manager, presets, the dormant patient-related information including the personal information, exam record, user access record, etc. and the image data in the dormant patient folder are transmitted to the information storage unit 122 of the dormant patient information storage server 120.

The information transfer unit 114 that has carried out the above process deletes the dormant patient-related information and image data of the dormant patient folder in the picture archiving communication server 110 except for the minimum identification information. Here, the minimum identification information denotes information that indicates that the dormant patient folder existed in the past and has been transferred to the dormant patient information storage server 120.

Through the processes as described above, a storage unit, not depicted, of the picture archiving communication server 110 can maintain the quantity of the patient-related information and image data at an appropriate level.

Meanwhile, the dormant patient information storage server 120 is composed of an information storage unit 122 and an information restoring unit 124. The information storage unit 122 receives and stores the dormant patient-related information and image data from the information transfer unit 114 as described above.

Comparing the dormant patient information storage server 120 with the picture archiving communication server 110, the dormant patient information storage server 120 is a server configured separately for receiving and storing the related information and image data of the dormant patients decided as the dormant state from the picture archiving communication server 110 and the structure of the dormant patient information storage server 120 and the configuration of the information storage unit 122 may have the same form as the picture archiving communication server 110.

However, since the access frequency by the user to the picture archiving communication server 110 is high, it is necessary to maintain a high availability, whereas, since the search frequency by the user to the dormant patient information storage server 120 is low, the demand for the availability is not so much high.

Accordingly, in consideration of the availability or economical efficiency, it is desirable that the system requirements and the maintenance cost of the dormant patient information storage server 120 be lower than those of the picture archiving communication server 110.

Meanwhile, if there is a visit reservation, an exam reservation, a special demand of the user, or a visit reservation of a dormant patient decided as a dormant state, the filter unit 112 restores the corresponding dormant patient folder of the information storage unit 122 in which the related information and image data of the corresponding dormant patient are stored. To this end, the filter unit 112 classifies the dormant patient folder containing the related information and image data of the corresponding dormant patient as a restoring patient folder, and records an identifier for identifying the restoring patient folder in a restoring identifier list to be stored.

For example, if receiving a visit reservation of John Doe decided as a dormant state, the Gil-dong HONG folder stored in the information storage unit 122 is classified as a restoring patient folder and an identifier of John Doe is recorded and stored in the restoring identifier list to restore the John Doe folder in the picture archiving communication server 110.

Next, the information restoring unit 124 searches for the restoring identifier list stored in the filter unit 112 at the time that the user presets. If there is an additional item according to the visit reservation, the exam reservation, or the special demand of the user, the information restoring unit 124 transmits the related information and image data of the corresponding patient stored in the restoring patient folder of the information storage unit 122 to picture archiving communication server 110 to restore the information in the corresponding folder.

Through the above-described process, the folder of the corresponding patient can perform the same function before it is classified as the dormant state.

Here, it is desirable that the user be the manager who manages the system 100 for managing information of dormant patients. Moreover, the manager can find an added item by searching for the restoring identifier list stored in the filter unit 112. Furthermore, it is possible to set the time for periodically finding an added item in the restoring identifier list and further to set the system to conduct a search for the restoring identifier list automatically.

Meanwhile, the information restoring unit 124 is included in the dormant patient information storage server 120 in the preferred embodiment of the present invention, but not limited thereto. That is, it is possible to provide the information restoring unit 124 in the picture archiving communication server 110 so that the related information and image data stored in the restoring patient folder are restored in the corresponding folder.

After the process of classifying a dormant patient folder as a restoring patient folder and recording an identifier in the restoring identifier list to be stored as a visit reservation of a dormant patient who has been decided as a dormant state is received, if the visit reservation is cancelled, it is desirable that the restoring patient folder of the corresponding patient in the information storage unit 122 be classified again as the dormant patient folder and the identifier stored in the restoring identifier list in the filter unit 112 be deleted.

Moreover, after having completed the process of transmitting the related information and image data stored in the restoring patient folder of the information storage unit 122 to the picture archiving communication server 110 and restoring the same as a visit reservation of a dormant patient who has been decided as a dormant state is received, if the visit reservation would be cancelled, it is desirable that the patient folder of the corresponding patient be classified again as the dormant patient folder and the identifier of the dormant patient folder be recorded and stored again in the dormant patient identifier list.

Hereinafter, the description will be made as to the process in which the related information and image data of the dormant patient who has been decided as a dormant state are transmitted and stored to the information storage unit 122 with reference to FIG. 2.

The dormant states of patients are decided under the predetermined dormant conditions by searching for the medical records of patients stored in the picture archiving communication server 110 at the time that the user presets, the folders in which the related information and image data of dormant patents decided as the dormant state are stored are classified as dormant patient folders, and identifiers of the dormant patient folder are recorded and stored in the dormant identifier list (S200).

By reading the dormant identifier list stored in the filtering step (S200), the dormant patient-related information and image data in the dormant patient folders corresponding to the dormant identifier list are transmitted to the information storage unit 122 of the dormant patient information storage server 120, and the dormant patient-related information and image data in the dormant patient folders in the picture archiving communication server 110 are deleted except for the minimum identification information (S210).

The dormant patient-related information and image data transmitted in the information transfer step (S210) are received and stored (S220).

Subsequently, the flow of transmitting the dormant patient-related information and image data stored in the information storage unit 122 to the picture archiving communication server 110 and restoring the same as decided as the dormant state will be described with reference to FIG. 3.

If there is a visit reservation of a patient who has been decided as a dormant patient, the dormant patient folder of the information storage unit 122 in which the corresponding dormant patient-related information and image data are stored is classified as a restoring patient folder, and an identifier of the restoring patient folder is recorded and stored in the restoring identifier list (S300).

If there is an added item, after having searched for the restoring identifier list stored in the filtering step (S300) at the time that the user presets, the patient-related information and image data stored in the restoring patient folder are transmitted to the picture archiving communication server 110 and the corresponding folder is restored (S310).

Meanwhile, if the visit reservation of the dormant patient entered in the restoring identifier list in the filtering step (S300) is cancelled, it is desirable that the restoring patient folder of the information storage unit 122 of the corresponding patient be classified again as the dormant patent folder and the folder identifier be deleted from the restoring identifier list.

Moreover, if the visit reservation is cancelled after having completed the restoration, it is desirable that the corresponding patient folder should be classified again as the dormant patient folder and the identifier of the dormant patient folder be recorded and stored again in the dormant identifier list.

As described above, although the present invention has been described and illustrated with reference to preferred embodiments and drawings, it should be understood that various modifications and variations of the present invention can be made thereto by those skilled in the art without departing from the spirit and the technical scope of the present invention as defined by the appended claims.

1. A system for managing information of dormant patients comprising a picture archiving communication server including a plurality of patient folders containing patient-related information and image data, and a dormant patient information storage server including a plurality of dormant patient folders containing dormant patient-related information and image data,
wherein the picture archiving communication server includes:
a filter unit that searches for medical records of patients stored in the picture archiving communication server at a time that a user presets to decide dormant state under predetermined dormant conditions, classifies a folder, in which the dormant patient-related information and image data of a dormant patient decided as a dormant state are stored, as a dormant patient folder, and records an identifier of the dormant patient folder in a dormant identifier list to be stored; and
an information transfer unit that reads the dormant identifier list stored in the filter unit at a time that the user presets to transmit the related information and image data in the dormant patient folder corresponding to the dormant identifier list to an information storage unit of the dormant patient information storage server, and deletes the related information and image data in the dormant patient folders in the picture archiving communication server except for minimum identification information,
wherein the dormant patient information storage server includes an information storage unit receiving and storing the dormant patient-related information and image data transmitted from the information transfer unit, and
wherein the dormant patient information storage server has system requirements lower than those of the picture archiving communication server includes.

2. The system for managing information of dormant patients as recited in claim 1, wherein, if there is any one of a visit reservation, an exam reservation of a dormant patient decided as a dormant state and a demand of the user, the filter unit classifies the dormant patient folder of the information storage unit, in which the dormant patient-related information and image data are stored, as a restoring patient folder and recodes an identifier of the restoring patient folder in a restoring identifier list to be stored.

3. The system for managing information of dormant patients as recited in claim 2, wherein an information restoring unit transmitting the patient-related information and image data stored in the restoring patient folder of the information storage unit to the picture archiving communication system to restore the corresponding folder, if there is an added item after conducting a search for the restoring identifier list stored in the filter unit at a time that the user presets, is further included.

4. The system for managing information of dormant patients as recited in claim 3, wherein, if a visit reservation of a dormant patient entered in the restoring identifier list is cancelled, the filter unit classifies the restoring patient folder of the information storage unit of the corresponding patient as a dormant patient folder again and deletes a folder identifier of the corresponding patient from the restoring identifier list, and records an identifier of the dormant patient folder in the dormant identifier list to be stored again.

5. A method for managing information of dormant patients in a system for managing information of dormant patients comprising a picture archiving communication server including a plurality of patient folders containing patient-related information and image data, and a dormant patient information storage server including a plurality of dormant patient folders containing dormant patient-related information and image data, the method comprising:
a filtering step of searching for medical records of patients stored in the picture archiving communication server at a time that a user presets to decide dormant state under predetermined dormant conditions, classifying a folder, in which the dormant patient-related information and image data of a dormant patient decided as a dormant state are stored, as a dormant patient folder, and recording an identifier of the dormant patient folder in a dormant identifier list to be stored;
an information transfer step of reading the dormant identifier list stored in the filtering step at a time that the user presets to transmit the related information and image data in the dormant patient folder corresponding to the dormant identifier list to an information storage unit of the dormant patient information storage server, and deleting the related information and image data in the dormant patient folders in the picture archiving communication server except for minimum identification information; and
an information storing step of receiving and storing the dormant patient-related information and image data transmitted in the information transfer step.

6. The method for managing information of dormant patients as recited in claim 5, wherein, if there is any one of a visit reservation, an exam reservation of a dormant patient decided as a dormant state and a demand of the user, a step of classifying the dormant patient folder of the information storage unit, in which the dormant patient-related information and image data are stored, as a restoring patient folder, recoding an identifier of the restoring patient folder in a restoring identifier list to be stored is further included.

7. The method for managing information of dormant patients as recited in claim 6, wherein, if there is an added item after conducting a search for the restoring identifier list stored in the filter unit at a time that the user presets, a step of transmitting the patient-related information and image data stored in the restoring patient folder of the information storage unit to the picture archiving communication system to restore the corresponding folder is further included.

8. The method for managing information of dormant patients as recited in claim 7, wherein, if a visit reservation of a dormant patient entered in the restoring identifier list is cancelled, a step of classifying the restoring patient folder of the information storage unit of the corresponding patient as a dormant patient folder again, deleting a folder identifier of the corresponding patient from the restoring identifier list, and recording an identifier of the dormant patient folder in the dormant identifier list to be stored again is further included.
